(19) United States
(12) Patent Application Publication
(10) Pub. No.: US 2003/0195001 A1
(43) Pub. Date: Oct. 16, 2003

(54) System, method and apparatus for providing mobile wireless communication

(76) Inventors: Kazuyoshi Tari, Omiya-Shi (JP); Hiroyuki Unoki, Omiya-Shi (JP); Tumoru Nagira, Omiya-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/420,755

(22) Filed: Apr. 23, 2003

Related U.S. Application Data
(63) Continuation of application No. 09/467,171, filed on Dec. 20, 1999.

(30) Foreign Application Priority Data
Dec. 18, 1998 (JP) 10-361660

(51) Int. Cl. H04Q 7/20

(52) U.S. Cl. 455/435.2; 455/435.1; 455/552.1

(57) ABSTRACT

A mobile wireless system, method and apparatus for establishing a link between a terminal device and the Internet by communicating with a base station wireless apparatus of a wireless communicating apparatus having at least one wireless serve connected to the Internet and the base station wireless apparatus that is connected to the wireless server for performing wireless communication. Under a condition in which the mobile wireless apparatus can communicate with multiple base station wireless apparatuses, when the base station wireless apparatus, which communicated with the mobile wireless apparatus, currently communicates with another mobile wireless apparatus, the mobile wireless apparatus communicates with another base station wireless apparatus obtained by selecting from among a plurality of other base station apparatuses, which are located in neighboring communication areas of the base station wireless apparatus and have available communication links. Program instructions for implementing the method are stored in a computer readable medium.

### CROSS REFERENCE TO RELATED APPLICATION

This application claims benefit of priority to Japanese Patent Application No. JP10-361,660 filed Dec. 18, 1998, the entire content of which is incorporated by reference herein.

### BACKGROUND OF THE INVENTION

1. Filed of the Invention

The present invention relates to a wireless communication system, particularly to a mobile wireless apparatus communicating with a base station wireless apparatus that is connected to the wireless server.

2. Discussion of the Background

A wireless communication system is described in Japanese Patent Publication No. 10-262,099. As a first feature, the disclosed wireless communication system includes at least one wireless server, which is connected to the Internet, and a base station wireless apparatus, which is connected to the wireless server and communicates with a mobile wireless apparatus that is connected to the terminal device. A single one of the wireless servers, which is assigned as a home wireless server, communicates with a mobile wireless apparatus in a service area of the base station wireless communication apparatuses thereof, whereby the terminal device of the mobile wireless apparatus is allowed to access the Internet.

As a second feature, the wireless communication system includes a terminal authentication managing system and a terminal managing system. The terminal authentication managing system authenticates the validity of access of the terminal device to the wireless server in accordance with a registration request from the terminal device. The terminal managing system issues one of the currently available IP addresses and registers the terminal device for access to the Internet in accordance with an Internet Protocol (IP) address issue request from the terminal device.

As a third feature of the wireless communication system, when another wireless server, other than a home wireless server, is requested by a terminal device to register the terminal device, the other wireless server requests, via the Internet, the home wireless server of the terminal device to authenticate access of the terminal device to the other wireless server as well as to issue an IP address for the terminal device. When authentication and IP address issuance processes are successful, the terminal device is permitted to access the other wireless server.

As a fourth feature of the wireless communication system, the wireless server further includes a routing system in which, when the terminal device is connected to a wireless server other than a home server, and when a previous wireless server of the terminal device receives packet data for the terminal device, the previous wireless server forwards the packet data to the wireless server that is currently connected to the terminal device based on the IP address obtained from the home wireless server.

As a fifth feature of the wireless communication apparatus, when a terminal device is connected to a wireless server other than a home wireless server, and when the wireless server receives forwarded packet data for the terminal device, a wireless server that is attached to the Internet, which transmitted the packet data, is informed of which wireless server is currently connected to the terminal device. Thereafter, the packet data, which is sent to the terminal device, is directly sent to the wireless server without passing through the previous wireless server of the terminal device.

When the terminal device of the mobile wireless apparatus communicates with a base station wireless apparatus, and when the base station wireless apparatus is busy communicating with another mobile wireless apparatus (“busy state”), the mobile wireless apparatus must wait for the “busy state” to be interrupted or terminated. Furthermore, in the case in which the mobile wireless apparatus uses other base station wireless apparatuses and has no channel information (operating frequencies and the like) of which other base station wireless apparatuses are in the neighborhood of the communication area of the one base station that is wirelessly connected to the terminal device, the mobile wireless apparatus must obtain channel information of the neighboring base station wireless apparatuses via the one wirelessly connected thereto.

### SUMMARY OF THE INVENTION

Accordingly, it is an object of the present invention to provide a mobile wireless apparatus and a wireless server capable of selectively switching among base station wireless apparatuses in accordance with communication traffic. It is another object of the present invention to provide the mobile wireless apparatus and a wireless server capable of obtaining channel information and the like of other neighboring base station wireless apparatuses by utilizing the idle time when the mobile wireless apparatus is not engaged in communication.

To this end, according to a first aspect of the invention, there is provided a mobile wireless apparatus for establishing a link between a terminal device and the Internet by communicating with a base station wireless apparatus of a wireless communication apparatus that has at least one wireless server that is connected to the Internet. The base station wireless apparatus is connected to the wireless server. The mobile wireless apparatus can communicate with multiple base station wireless apparatuses; when the mobile wireless apparatus is communicating with a particular base station wireless apparatus, the mobile wireless apparatus can select from among a plurality of other neighboring base station apparatuses that have available communication links.

During an idle time, the mobile wireless apparatus can obtain and store base station information of the neighboring other base station wireless apparatuses from the packets that are transmitted from these base station wireless apparatuses. Accordingly, the mobile wireless apparatus can select another base station wireless apparatus based on the base station information.

Further, the mobile wireless apparatus may include a receiving unit that receives a wireless signal and outputs the received-data, a PLL unit that is connected to the receiving unit and demodulates the wireless signal, a storage unit that stores base station information associated with the base station wireless apparatuses, a received-data analyzing device that analyzes the received-data, a data processing device that extracts the base station information from the analyzed received-data and stores the base station information in the storage unit, and a base station selecting device that synchronously switches settings for the received-data analyzing unit and the PLL unit based on the base station information that is stored in the storage unit.

According to a second aspect of the invention, there is provided a wireless server for a wireless communication apparatus. At least one wireless server is connected to the Internet and a base station wireless apparatus. The base station wireless apparatus communicates with a mobile wireless apparatus that is connected to a terminal device, wherein the wireless server causes multiple base station wireless apparatuses, whose communication areas overlap, to synchronously transmit wireless signals with control data at different points in time.

Further, when the communication area of the base station wireless apparatus that is connected to the wireless server overlaps with those of the other base station wireless apparatuses, the wireless server may cause each base station wireless apparatus to transmit wireless signals with control data at different times by synchronizing with the other wireless servers, which are connected to these other base station wireless apparatuses.

According to a third aspect of the invention, there is provided a computer-readable containing medium containing a base station selecting program for a mobile wireless apparatus, the program causing a computer to execute the steps of: analyzing received-data transmitted from a receiving base station wireless apparatus; extracting and storing base station information from the received-data; and changing a process of analyzing the received-data and the oscillating frequency of a PLL unit in accordance with the receiving base station wireless apparatus based on the base station information.

The above approach of the wireless communication system is advantageous because a single wireless server is assigned as a home server for the terminal devices, whereby access of a terminal device is authenticated and an IP address is issued. Additionally, the terminal device can communicate with a wireless server even though the terminal device is out of the communication area of the home server.

Moreover, another advantage exists in that the terminal device can request an IP address from a wireless server that may not be the home wireless server of the terminal device. The home wireless server can issue the IP address via the wireless server that the terminal device currently is in direct communication with. Accordingly, the terminal device can access another wireless server without changing a configuration of the IP address thereof.

Yet another advantage is that heavy communication traffic can be minimized because all the wireless servers need not be notified of the transition of the terminal device whenever the terminal device moves to another communication area.

Delay that is experienced by the mobile wireless apparatus as a result of heavy communication traffic between the mobile wireless apparatuses and base station wireless apparatuses is diminished because the mobile wireless apparatus can select an available base station wireless apparatuses among multiple base station wireless apparatuses.

Because the mobile wireless apparatus obtains, via the base station wireless apparatus communicated therewith, base station information of the base station wireless apparatuses in neighboring communication areas during the idle time, the mobile wireless apparatus can quickly perform a selection-switching process based on the obtained base station information.

In the present invention because each base station wireless server synchronously transmits control data at different times, the mobile wireless apparatus can receive the control data using a time-division scheme from each of the base station wireless apparatuses.

In addition, because synchronization is performed among multiple wireless servers, each base station wireless apparatus can synchronously transmit the control data at a different time, even though wireless servers connected to each base station wireless server are different.

### BRIEF DESCRIPTION OF THE DRAWINGS

FIG. 1 is a block diagram showing a construction of a mobile wireless apparatus according to an embodiment of the present invention;

FIG. 2 shows one example in which the mobile wireless apparatus is located in a communication area of multiple base station wireless apparatuses which are connected to the same wireless server according to an embodiment of the present invention;

FIG. 3 shows one example of timing of signals transmitted through transmission channels of multiple base station wireless apparatuses and responses of the mobile wireless apparatus to the signals according to an embodiment of the present invention;

FIG. 4 shows one example in which the mobile wireless apparatus is located in the communication area of the base station wireless apparatus connected to another wireless server according to an embodiment of the present invention;

FIG. 5 shows a block diagram of a wireless communication system according to one embodiment of the present invention;

FIG. 6 illustrates a process of transmitting a packet in the system of FIG. 5;

FIG. 7 is a flow chart showing the process of transmitting a packet in the system of FIG. 5;

FIG. 8 is a flow chart showing the process of transmitting a packet to a terminal unit in a different communication area in the system of FIG. 5;

FIG. 9 is the flow chart showing the process of transmitting a packet to a terminal unit in the system of FIG. 5;

FIG. 10 is the flow chart showing the process of transmitting a packet to a host server in the system of FIG. 5;

FIG. 11 illustrates a process of issuing an address in the system of FIG. 5;

FIG. 12 illustrates a system for authenticating a terminal in the system of FIG. 5; and

FIG. 13 illustrates the process of authenticating the terminal in the system of FIG. 5.

### DESCRIPTION OF THE PREFERRED EMBODIMENTS

Embodiments of the present invention are described with reference to the accompanying drawings.

FIG. 1 is a block diagram showing a construction of a mobile wireless apparatus M according to one embodiment of the present invention. The mobile wireless apparatus M includes the following components: a receiving unit Mₐ that receives a wireless signal and outputs the received signal; a phase locked loop (PLL) unit M_{b} (which includes a PLL circuit) that is connected to the receiving unit Mₐ and demodulates the received signal; a received-data analyzing unit M_{c} that analyzes the received-data; a data processing unit M_{d} that extracts and saves, from the analyzed received-data, base station information of base station wireless apparatuses, which includes channel information (e.g., operating frequencies and the like) of base station wireless apparatuses and communication-link information (e.g., availability of communication-links and the like); a base station selecting unit Mₑ that synchronously switches between the PLL unit M_{b} and the receiving data analyzing unit M_{c} based on the base station information; and a storage unit M_{f} that stores the base station information.

The mobile wireless apparatus M is assumed to store channel information of the base station wireless apparatuses in the storage unit M_{f} before the mobile wireless apparatus moves across a different communication area. In addition, a wireless server, a component of the wireless communication system, has the base station information of all neighboring base station wireless apparatuses. The base station information is transmitted by way of a transmission channel (down-line channel) from a base station wireless apparatus, which is a component of the wireless system. The wireless server and the base station wireless apparatus are described in detail below.

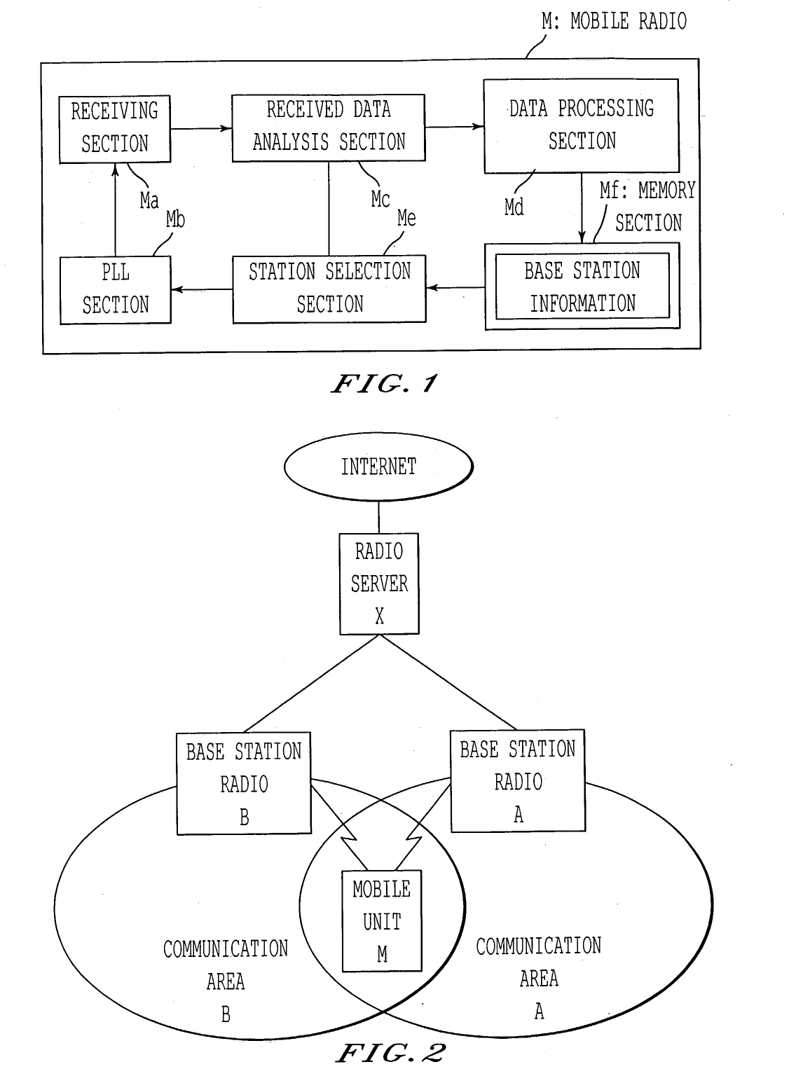

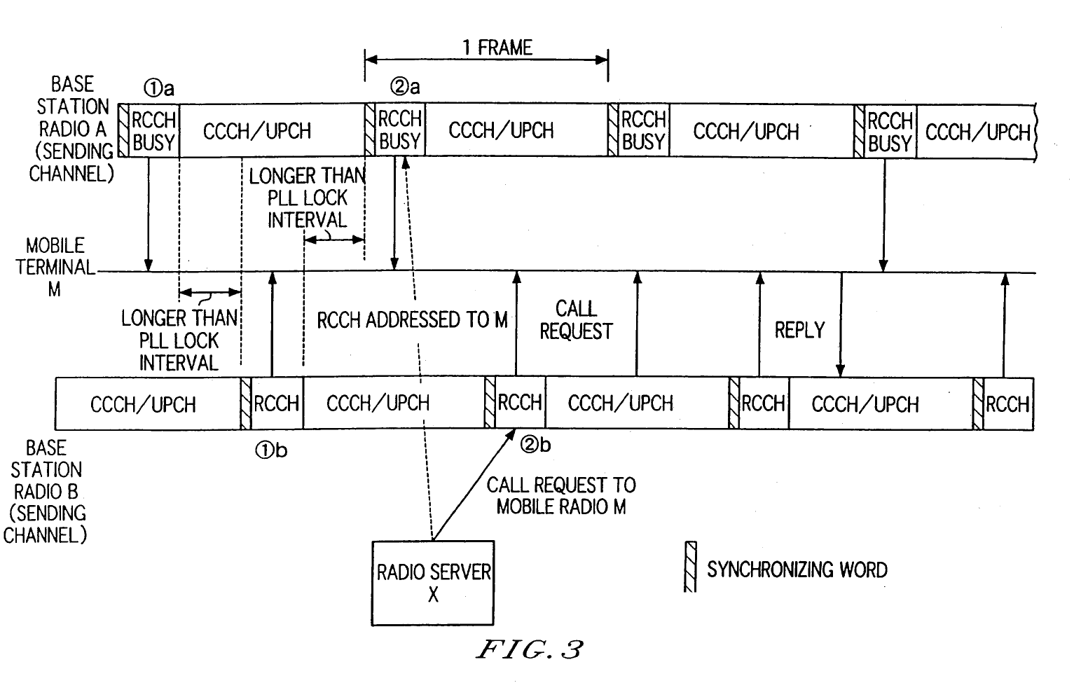

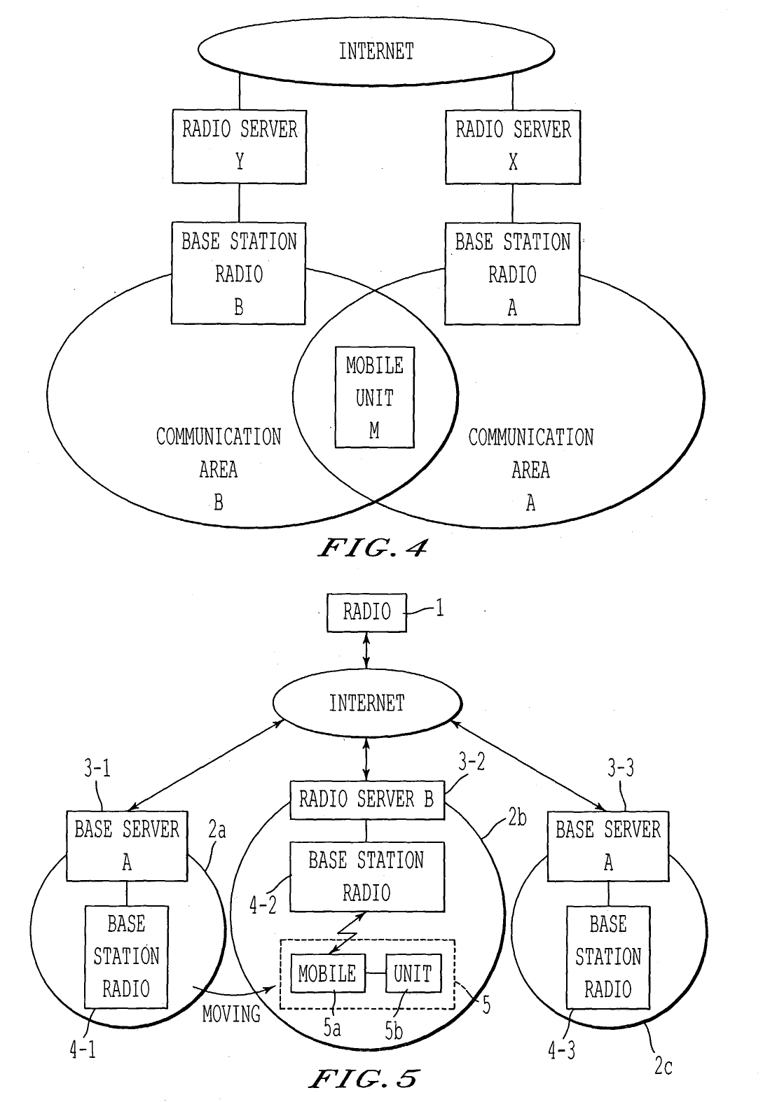

Operations of the mobile wireless apparatus M are described with reference to FIGS. 2 and 3. For purposes of explanation, the operations are described particularly in a case in which the mobile wireless apparatus is located in an overlapping region of communication areas A and B for multiple base station wireless apparatuses A and B respectively, as shown in FIG. 2. It is recognized by one of ordinary skilled in the art that any number of base station wireless apparatuses may be used. FIG. 3 shows signals through transmission channels between two base station wireless apparatuses A and B and the mobile wireless apparatus, and also shows transmission timing thereof. Half-duplex operation is employed between the base station wireless apparatus and the mobile wireless apparatus. Accordingly, the base station wireless apparatus constantly transmits packets using a transmission channel (down-line channel), and the mobile wireless apparatus responds to the packets by using an up-line channel when the destination of the packets is the mobile wireless apparatus.

In each transmission channel of base station wireless apparatuses A and B, data are transmitted sequentially frame by frame. The frame includes the following fields: unique word (UW); radio control channel (RCCH); common control channel (CCCH) or user packet channel (UPCH). The UW data is a bit stream in the header of each frame for frame-synchronization, and has a particular value. The RCCH data includes states of communication channels and information designating which mobile wireless apparatus a base station wireless apparatus communicates with, and is transmitted to all mobile wireless apparatuses. In FIG. 3, “RCCH busy” signifies that the destination of a frame having “RCCH busy” is a mobile wireless apparatus other than the mobile wireless apparatus M. In an exemplary embodiment, the CCCH data includes control information (e.g., calling request and the like), channel information of neighboring base station wireless apparatuses. The CCCH data is transmitted to at least one mobile wireless apparatus that is designated by the RCCH data. The UPCH data includes data that is to be transmitted to a mobile wireless apparatus, and is transmitted to at least one mobile wireless apparatus as designated by the RCCH data.

A wireless server X (FIG. 2) controls the base station wireless apparatuses A and B so that a predetermined period (at least the locked time of the PLL unit M_{b}) of data transmission time lag occurs between base station wireless apparatuses A and B. In FIG. 3, the base station selecting unit Mₑ obtains base station information (e.g., channel information of the base station wireless apparatus A in this example) from the storage unit M_{f}. The base station selecting unit Mₑ also changes the oscillating frequency of the PLL unit M_{b} so as to receive a signal from a transmission channel of the base station wireless apparatus A, and prepares the received-data analyzing unit M_{c} so that the received-data analyzing unit M_{c} analyzes the received-data.

The receiving unit Mₐ receives data from the transmission channel of the base station wireless apparatus A. Initially, RCCH busy (1)a is demodulated. The received-data analyzing unit M_{c} analyzes the received RCCH busy data (1)a. Because the RCCH busy data (1)a indicates that the destination of this frame is not the mobile wireless apparatus M, the received-data analyzing unit M_{c} causes the base station selecting unit Mₑ to select another base station wireless apparatus. The base station selecting apparatus Mₑ obtains the base station information of other base station wireless apparatuses (the base station wireless apparatus B in this example) from the storage unit M_{f}. In the same way as in the case in which the base station wireless apparatus A is selected, the base station selecting unit Mₑ controls the PLL unit M_{b} and the received-data analyzing unit M_{c}. The receiving unit Mₐ can receive and demodulate the signal from the transmission channel of the base station wireless apparatus B after the locked time from when the PLL unit M_{b} changes the oscillating frequency thereof. The received-data analyzing unit M_{c} analyzes the received RCCH data (1)b. If the RCCH data (1)b indicates the mobile wireless apparatus M as the destination of the frame and the CCCH data follows, the data processing section M_{d} extracts the base station information of the neighboring base station wireless apparatuses from the CCCH data, saving this information in the storage unit M_{f}. Accordingly, the base station information in the storage unit M_{f} is updated.

In FIG. 3, a scenario is shown in which a call request is made from the wireless server X to the mobile wireless apparatus M. At this time, because the base station wireless apparatus A is busy transmitting frames to another mobile wireless apparatus, the wireless server X transmits the call request of the mobile wireless apparatus M to the base station wireless apparatus B. In this case, the mobile wireless apparatus M selects a transmission channel of the base station wireless apparatus A and receives RCCH busy data (2)a. Since it is discovered that the mobile wireless apparatus M is not the destination of the frame, the mobile wireless apparatus M then selects a transmission channel of the base station wireless apparatus B, and receives RCCH data (2)b. Because the RCCH data (2)b shows that the destination of the frame is the mobile wireless apparatus M, the mobile wireless apparatus M acquires the frame, whereby the call request in the CCCH data of the frame is accepted. The mobile wireless apparatus M responds to the calling request. Therefore, when the mobile wireless apparatus M needs to transmit a packet, the mobile wireless apparatus M can select an available channel on a base station wireless apparatus.

In the description of FIGS. 2 and 3, two base station wireless apparatuses are provided for explanatory purposes. However, more base station wireless apparatuses may be utilized. As discussed above, by sequentially scanning the transmission channels of each base station wireless apparatus based on the base station information, a base station wireless apparatus with an available channel can be selected. As seen in FIG. 2, when the mobile wireless apparatus is located in the overlapped communication area of two base station wireless apparatuses A and B, as long as the condition (CCCH time or UPCH time)≦(locked time of the PLL unit×2+UW+RCCH transmission (or receiving) time) holds, it is possible to perform the sequential scan of each transmission channel of base station wireless apparatuses. For example, as long as the locked time of PLL unit is not more than 10 ms and the time cycle of one frame is 40 ms (UW+RCCH time is 10 ms, CCH or UPCH time is 30 ms), it is possible to receive, during the time cycle of one frame, the RCCH data from the transmission channels of the other base station wireless apparatuses.

FIG. 2 shows an exemplary case in which the single wireless server is connected to multiple base station wireless apparatuses. In this case, registration and authentication of the mobile wireless apparatus to the wireless server are performed once. Accordingly, there is no need to repeat the registration and authentication process whenever the mobile wireless apparatus moves to another base station wireless apparatus. The registration and authentication processes are described in detail below.

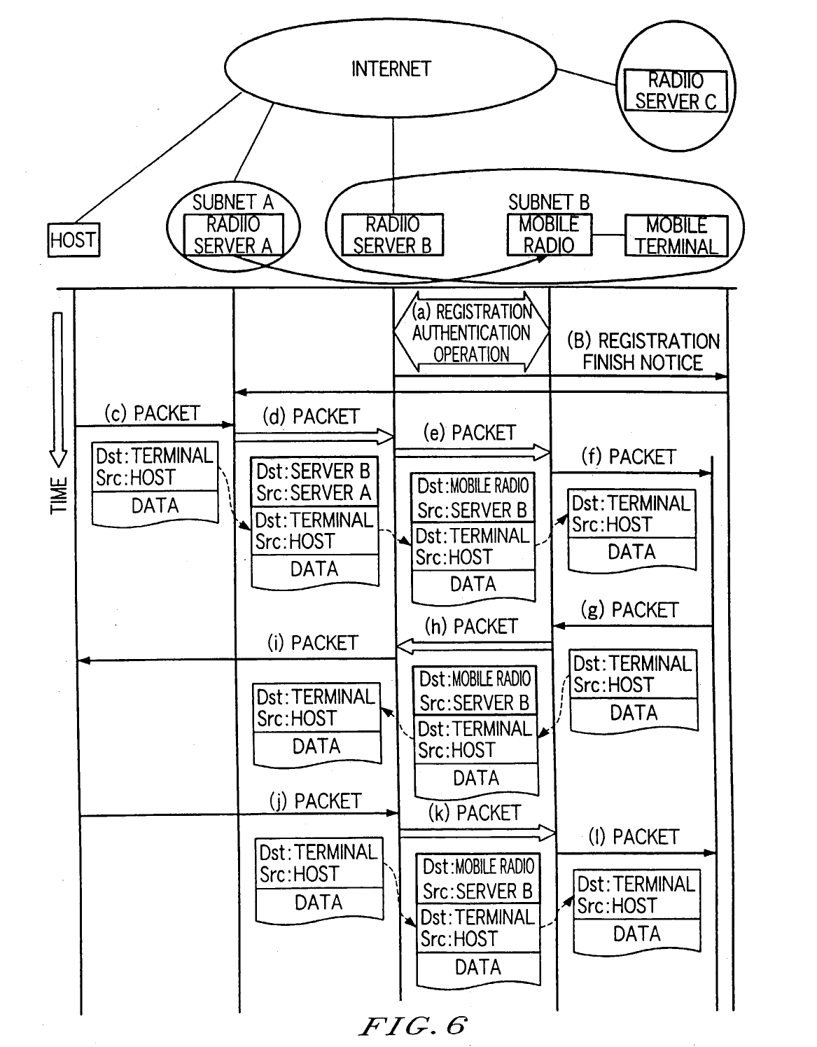

FIG. 4 shows an exemplary case in which the mobile wireless apparatus M is located in an overlapping region of the communication areas A and B for multiple base station wireless apparatuses A and B respectively. Furthermore, base station wireless apparatuses A and B are connected to wireless servers X and Y, respectively. As in the operation of FIG. 3, the system of FIG. 4 has a data flow between signals from two base station wireless apparatuses A and B and the mobile wireless apparatus M. Because wireless servers X and Y, which are connected to base station wireless apparatuses A and B, respectively, are different, when a terminal device of the mobile wireless apparatus M, which is already registered with and authenticated by the wireless server X, is switched to the different wireless server Y, the terminal device is registered with and is authenticated by the wireless server Y via the base station wireless apparatus B. After the completion of registration and authentication of the mobile wireless apparatus M, the wireless server Y informs the wireless server X that the terminal device is registered with the wireless server Y. When the wireless server X receives this message, the registration of the terminal device is deleted.

Further, wireless servers X and Y have information such as locations of the base station wireless apparatuses under their control as well locations of the base station wireless apparatuses that are not under their control, whose communication areas are overlapped with those of the base station wireless apparatuses under their control. Each wireless server may obtain information about transmission timing of signals in the transmission channels of the base station wireless apparatuses from other wireless servers. In addition, wireless servers X and Y control transmission timing of signals in the transmission channels of base station wireless apparatuses A and B by individually synchronizing with, for example, timing information that is contained in a signal transmitted from a Global Positioning System (GPS).

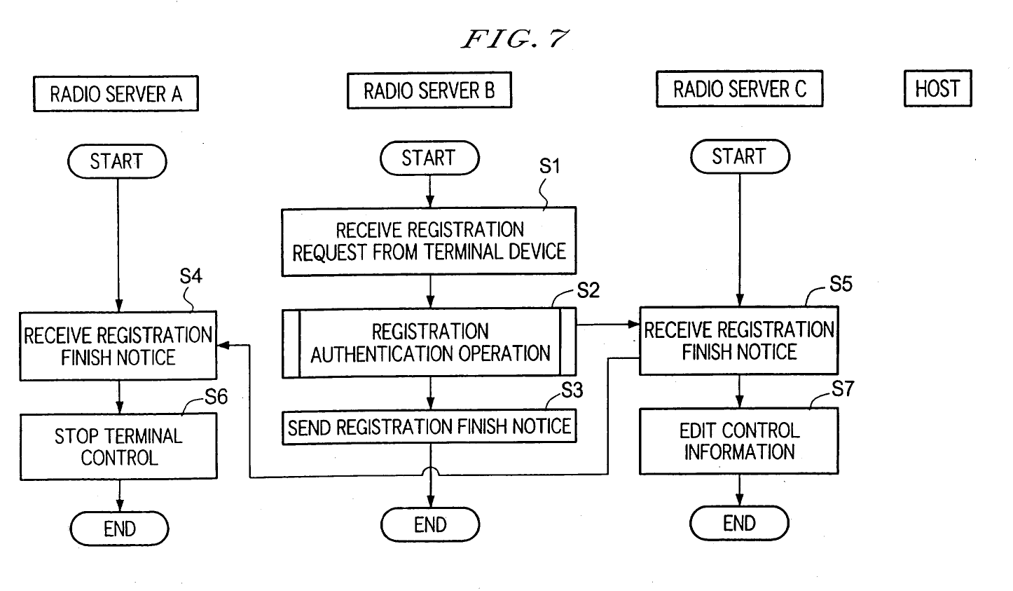

Attention is now drawn to a wireless communication system that employs a mobile wireless apparatus and a wireless server in accordance with an embodiment of the present invention as shown in FIG. 5. A host server 1 connects to a network 2, which is attached to wireless servers 3-n (i.e., 3-1, 3-2, and 3-3). Sub-networks 2a, 2b, and 2c are formed under the network 2. A base station wireless apparatuses 4-n (4-1, 4-2, and 4-3) are connected to a single wireless server (for the purposes of explanation, only the single base station wireless apparatus 3-n and the corresponding single wireless server 4-n are shown). A terminal device 5 communicates with the wireless server 3-2. The terminal device 5 includes a mobile wireless apparatus 5a (hereinafter referred to as “mobile apparatus”) communicates with the base station apparatus 4-2, and a computer terminal unit 5b that is connected to the mobile apparatus 5a.

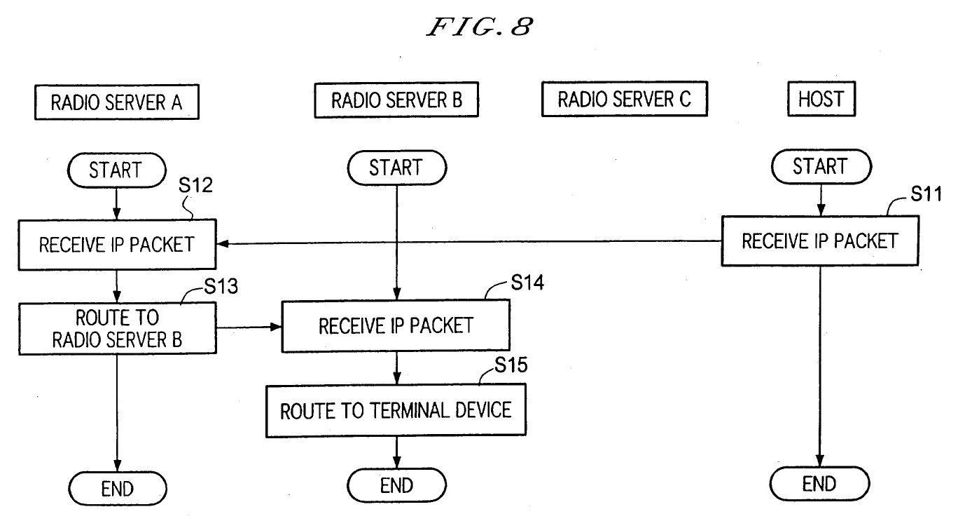

The terminal device 5 has, as the home server, one of the wireless servers connected to the network 2. In the example of FIG. 5, the wireless server C 3-3 is the home server of the terminal 5. Wireless servers X and Y, and base station wireless apparatuses A and B and the mobile wireless apparatus M of FIG. 4 represent any two wireless servers 3-n (n=1, 2, . . . ), any two base station wireless apparatuses 4-n (n=1, 2, . . . ), and the mobile wireless 5a, respectively. Operations of the wireless communication apparatus according to the embodiment of the present invention, are described with reference to FIGS. 6 to 10.

FIG. 6 shows a timing diagram of the operation of wireless communication system. In FIG. 6, “Dst” indicates the destination of a packet and “Src” indicates the source of the packet. FIGS. 7-10 are flow charts showing procedures of the wireless communication system.

By way of example, the terminal device 5 is assumed to have the wireless server C 3-3 as the home server and is currently under control of the wireless server A 3-1. A scenario in which the terminal device 5 moves from a sub-network 2a with wireless server A 3-1 to sub-network 2b with wireless server B 3-2 is described.

The terminal device 5 issues a request for registration-authentication and an IP address (represented by (a) in FIG. 6, and step S1 in FIG. 7) from the wireless server B 3-2. In response, the wireless server B 3-2 authenticates to permit access and issues the IP address (represented by (a) in FIG. 6, and step S2 in FIG. 7), thereby enabling the terminal device 5 to be under the control of the wireless server B 3-2. The registration-authenticating process and the IP address issuing process are more fully described below.

The wireless server B 3-2 informs the wireless server C 3-3 (the home server) that the authentication-registration process of the terminal device 5 is completed due to the management transition thereof from the wireless server A 3-1 to the wireless server B 3-2 (represented by (b) in FIG. 6, and step S3 in FIG. 7).

In accordance with the above information about the registration completion from the wireless server B 3-2, the wireless server C 3-3 (home server) informs the wireless server A 3-1 that the terminal device 5 is moved to the sub-network 2b and is kept under the control of the wireless server B 3-2 (step S5 in FIG. 7). As a result, the wireless server A 3-1 receives the above information of the registration completion from the wireless server C 3-3 (home server) (step S4 in FIG. 7) and stops the management of the terminal device 5 (step S6 in FIG. 7). The wireless server C 3-3 (home server) records that the terminal device 5 is kept under control of the wireless server B 3-2, and updates the management information thereof (step S7 in FIG. 7).

The reason that the wireless server A 3-1 is notified of the transition of terminal device 5 via the wireless server C 3-3 (home server) is to have the wireless server A 3-1 be aware that the wireless server A 3-1 currently manages the terminal device 5. Such operations enable the terminal device 5 to be under control of another wireless server.

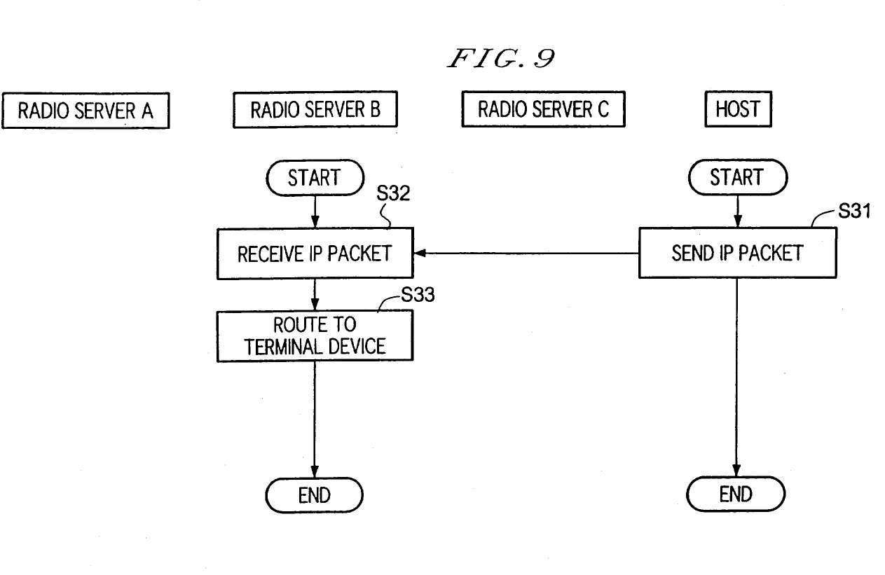

With reference to FIGS. 6 and 8, various operations are described in which the host server 1 transmits a packet to the terminal device 5. The host server 1 transmits an IP packet through the network 2 to the terminal device 5 (step S11 in FIG. 8). Because the host server 1 is not aware that the terminal device 5 is under control of the wireless server B 3-2, the host server 1 transmits the packet to the previous wireless server A 3-1 of the terminal device 5 (represented by (c) in FIG. 6).

The wireless server A 3-1 receives the packet (step S12 in FIG. 8) and routes the packet to the wireless server B 3-2 (represented by (d) in FIG. 6, and step S13 in FIG. 8). Next, the wireless server B 3-2 receives the packet (step S14 in FIG. 8), and routes the packet (represented by (e) in FIG. 6) to the terminal apparatus 5a of the terminal device 5 (step S15 in FIG. 8). Finally, the packet is transmitted to the terminal 5b (represented by (f) in FIG. 6). Therefore, the terminal device 5 can receive the packet transmitted from the host server 1.

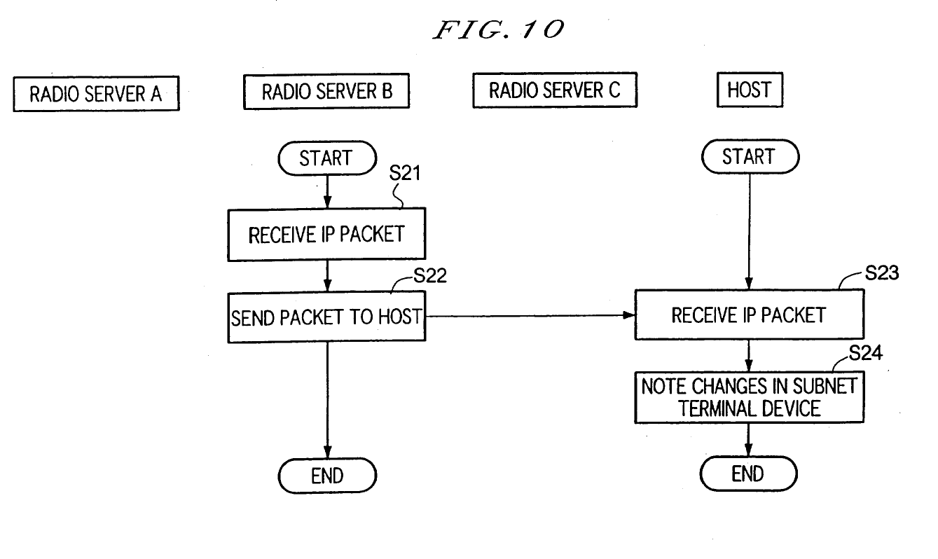

Next, operation of the wireless communication system are described, with reference to FIGS. 6, 9, and 10, in which the terminal device 5 transmits a packet to the host server 1. The terminal 5b transmits the packet to the mobile apparatus 5a (represented by (g) in FIG. 6). The mobile apparatus 5a then transmits the packet to the wireless server B 3-2 (represented by (h) in FIG. 6) via base station wireless apparatus 4-2. After receiving the packet, the wireless server B 3-2 (step S21 in FIG. 9) routes the packet to the host server 1 (represented by (i) in FIG. 6, and step S22 in FIG. 9). The host server 1 then receives the packet (step S23 in FIG. 9). Because the host server 1 can discover from the source address of the packet that the terminal device 5 is under the control of the wireless server B 3-2 (step S24 in FIG. 9), the terminal device 5 can transmit the packet directly to the wireless server B 3-2 thereafter.

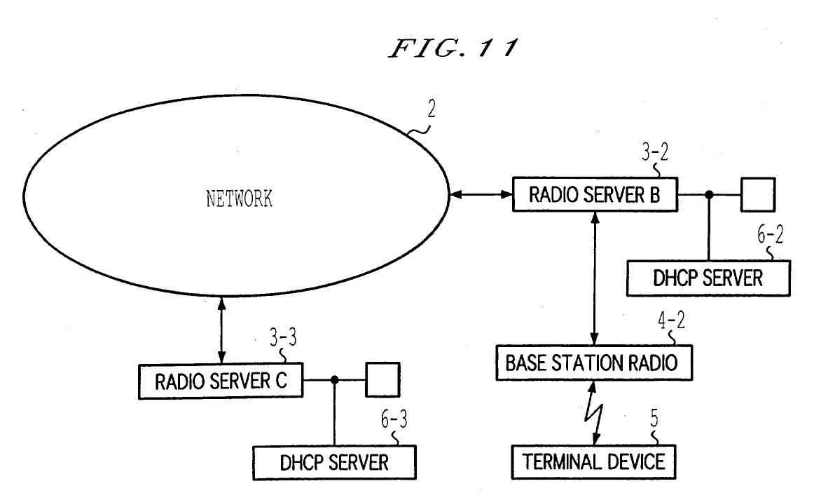

Operations are described below in which the host server 1 transmits a packet to the wireless server B3-2. The host server 1 transmits the packet to the wireless server B3-2 (represented by (j) in FIG. 6, and step S31 in FIG. 10). The wireless server B 3-2 receives the packet (step S32 in FIG. 10), and transmits the packet to the mobile apparatus 5a (represented by (k) in FIG. 6) by routing to the terminal device 5 (step S33 in FIG. 10 and represented by (1) in FIG. 6). Thus, when the packet is exchanged between a server and the terminal device 5, the packet is allowed to be forwarded irrespective of the position of the terminal device 5. Further, whenever the terminal device 5 moves to another communication area, there is no need to inform all wireless servers of the transition of the terminal device 5, thereby minimizing heavy communication traffic over the network 2.

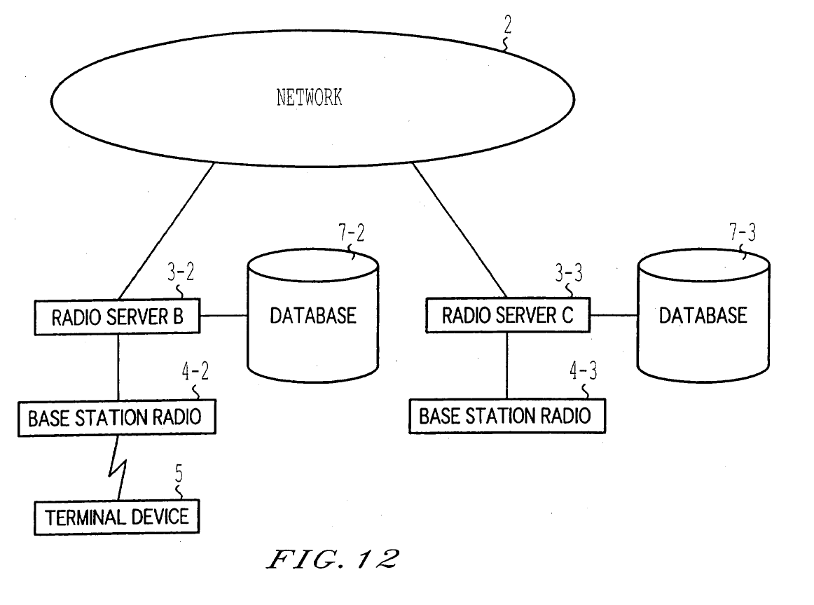

FIG. 11 illustrates a system for issuing an IP address in accordance with an embodiment of the present invention. When the terminal device 5 moves to the communication area of the wireless server B 3-2, the terminal device 5 requests the wireless server B 3-2 to issue the IP address. The wireless server B 3-2 identifies the home wireless server of the terminal device 5, which in this case is the wireless server C 3-3; then the wireless server B 3-2 requests the wireless server C 3-3 (home server) to issue the IP address. The wireless server C 3-3 (home server) requests an IP address from a Dynamic Host Configuration Protocol (DHCP) server 6-3, which is connected to the wireless server C 3-3. The DHCP server 6-3 issues a currently available IP address in response to the request, transmitting the IP address to the wireless server C 3-3. Thereafter, the wireless server C 3-3 transmits the issued IP address to the terminal device 5 via the wireless server B 3-2. In a different scenario in which the wireless server B3-2 is the home server of the terminal device 5, a DHCP server 6-2, which is connected to the wireless server B 3-2, may issue an IP address.

Because these operations enable the terminal device 5, which is under control of the wireless server B 3-2, to use the IP address that the wireless server C 3-3 issues, the terminal device 5 operates as though it is under control of the wireless server C 3-3 in spite of the fact that the packet is transmitted to the terminal device 5 via the wireless server B 3-2. Thus, when the terminal device 5 requests an IP address from a wireless server that the terminal device 5 is trying to access and may not be a home wireless server, the home wireless server can still issue the IP address via the current wireless server. Accordingly, the terminal device 5 can access another wireless server without changing a configuration of the IP address thereof.

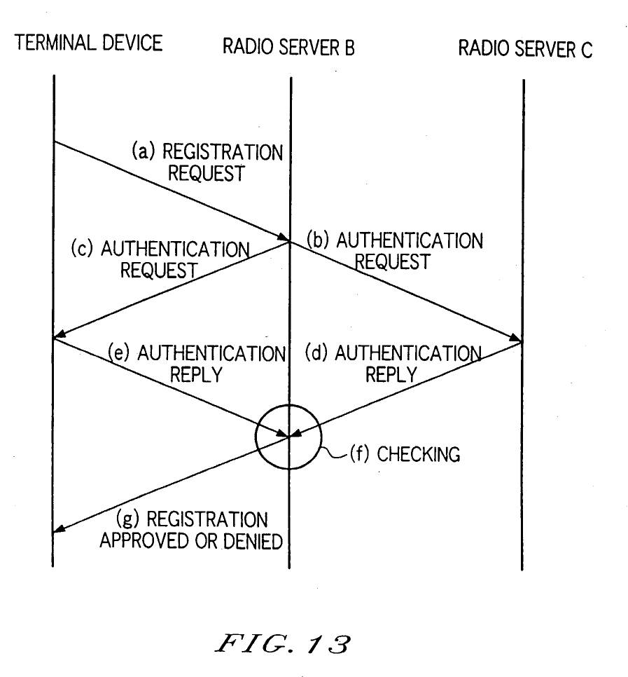

Referring now to FIGS. 12 and 13, the operation of registration-authentication is described. The terminal device 5 sends a registration request (represented by (a) in FIG. 13) and the identification number of the terminal device 5 to the wireless server B 3-2. The wireless server B 3-2 then queries whether the authentication data of the requesting terminal device 5 exists in a database 7-2, which is connected to the wireless server B 3-2. If the authentication data does not exist in the database 7-2, it is determined that the wireless server B 3-2 is not the home wireless server of the terminal device 5. The wireless server B 3-2 transmits an authentication request to the home server (the wireless server C 3-3 in this case) of the terminal device 5 as identified by the received identification number (represented by (b) in FIG. 13).

A random value that is generated by the wireless server B 3-2 and the identification number as registered by the terminal device 5 are also transmitted to the home server. Moreover, the random value is transmitted to the terminal device 5 (represented by (c) in FIG. 13).

The wireless server C 3-3 (home server) receives the authentication request and performs authentication processing using the received random value and identification number. The wireless server C 3-3 returns the result of the authentication processing to the wireless server B 3-2 (represented by (d) in FIG. 13). In addition, the terminal device 5 receives the random number from the wireless server B 3-2, and performs authentication processing, using the received random value. The terminal device 5 then returns the result of the processing to the wireless server B 3-2 (represented by (e) in FIG. 13). The wireless server B 3-2 compares the results of the authentication process received from both the wireless server C 3-3 and the terminal device 5 (represented by (f) in FIG. 13). If the results match, the registration-request is recognized (represented by (g) in FIG. 13); otherwise, the registration request is refused as an invalid registration request.

On the other hand, when the authentication data exists in the database 7-2 (i.e., because the wireless server B 3-2 is the home wireless server of the terminal device 5), the authentication process requires only the registration-request operation (represented by (a) in FIG. 13), the authentication-request operation (represented by (c) in FIG. 13), the authentication-response operation (represented by (e) in FIG. 13), and the registration-acknowledgment operation (represented by (g) in FIG. 13).

As described above, registration-authentication of a terminal device 5 can be performed even though the terminal device is not under control of the home server.

The use of the above described wireless communication apparatus enables a mobile terminal device to maintain communication between the wireless communication apparatus and the mobile terminal device even after the movement of the mobile terminal device to another communication area. The present invention has applicability to message communication (electronic mail, Internet news, file transfer via file transfer protocol (FTP), voice mail, WEB distribution, Computer Telephony Integration (CTI), telemetry, broadcast communication, Intelligent Transport System (ITS) (i.e., advanced road transportation system), and the like. In addition, the wireless communication apparatus can be applied to a push-type communication using a routing function.

The various embodiments of the present invention, as discussed herein, utilize a base station wireless apparatus and a wireless server in a wireless communication system. However the present invention is not limited to these embodiments. For example, the present invention may utilize a network such as a LAN (local area network) or dial up connection that is separate from the Internet and/or Intranet.

Furthermore, mobile wireless apparatus may select a base station by storing a base station selecting program for realizing the mobile wireless apparatus of the present invention in a computer-readable storage medium whereby the program is loaded from this medium into a computer system and executed.

Specifically, the program causes the computer to execute the following exemplary functions: a received-data analyzing function for analyzing received-data transmitted from a base station wireless apparatus which receives data; a function for extracting a base station information from the received-data and storing; and a function for changing a process using the function for analyzing the received-data and for changing the oscillating frequency of the PLL unit based on the base station information.

As used herein, a computer system includes an operating system (OS), and hardware such as peripheral devices. The computer-readable storage medium refers to a removable medium, such as a floppy disk, a magneto-optical disk, a read-only-memory (ROM), and CD-ROM and a storage device, such as a hard disk installed in the computer system. Furthermore, the computer-readable storage medium may be a communication link that dynamically stores a program for a short period. In addition, the computer-readable storage medium may be volatile memories in a client computer and a server computer of the computer system which store programs for a certain period of time when programs are transmitted through a communication link, such as a telephone line or a network (e.g., the Internet).

The above program may realize a part of the above described functions. Alternatively, the above program and already-existing programs in the computer system may collaborate to realize the above described functions.

Numerous modifications and variations of the present invention are possible in light of the above teachings. It is therefore to be understood that within the scope of the appended claims, the present invention may be practiced otherwise than as specifically described herein.

What is claimed as new and desired to be secured by Letters Patent of the United States is:

1. A mobile wireless apparatus comprising:
a receiving unit configured to receive a wireless signal and to output a corresponding received-data;
an analyzing unit configured to analyze the received-data;
a data processing section configured to extract base station information from the received-data; and
a base station selection section configured to select an available base-station wireless apparatus among a plurality of neighboring base-station wireless apparatuses based upon the base station information.

2. The apparatus according to claim 1, wherein the base station selection section selects the available base-station wireless apparatus during an idle time period.

3. The apparatus according to claim 1, further comprising:
a phase locked loop (PLL) unit coupled to the receiving unit configured to demodulate the wireless signal; and
a storage unit configured to store the base station information.

4. The apparatus according to claim 3, wherein the base station selection section controls the PLL unit to change oscillation frequency of the PLL unit.

5. The apparatus according to claim 1, wherein the received-data includes a Unique Word field, a Radio Control Channel (RCCH) field, and a Common Control Channel (CCCH) field or a User Packet Channel (UPCH) field.

6. A method of performing wireless communication with a plurality of base station wireless apparatuses, the method comprising:
receiving a wireless signal;
outputting a received-data corresponding to the received wireless signal;
analyzing the received-data;
extracting base station information from the received-data; and
selecting an available base-station wireless apparatus among a plurality of neighboring base-station wireless apparatuses based upon the base station information.

7. The method according to claim 6, wherein the selecting step is performed during an idle time period.

8. The method according to claim 7, further comprising:
demodulating the wireless signal; and
storing the base station information.

9. The method according to claim 6, wherein the received-data in the step of outputting includes a Unique Word field, a Radio Control Channel,(RCCH) field, and a Common Control Channel (CCCH) field or a User Packet Channel (UPCH) field.

10. A wireless communication system for providing communication with a terminal device over a network, comprising:
a wireless server connected to the network; and
a plurality of wireless base station apparatuses configured to communicate with the wireless server and the terminal device, the plurality of wireless base station apparatuses having overlapping communication areas, wherein the wireless server causes the wireless base station apparatuses to transmit synchronously wireless signals that have control data at different points in time.

11. The system according to claim 10, further comprising:
another wireless server connected to the network, each of the wireless servers communicating to share authentication and registration information of the terminal device.

12. The system according to claim 10, wherein the network is an Internet Protocol (IP) based network.

13. A computer readable medium storing program instructions for execution on a computer system, which when executed by a computer, cause the computer to perform the steps of:
receiving a wireless signal;
outputting a received-data corresponding to the received wireless signal;
analyzing the received-data;
extracting base station information from the received-data; and
selecting an available base-station wireless apparatus among a plurality of neighboring base-station wireless apparatuses based upon the base station information.

14. The computer readable medium of claim 13, wherein the computer readable medium further stores program instructions for causing the computer to perform the step of:
changing the analyzing step and oscillating frequency of a phase locked loop (PLL) unit based upon the base station information.

15. The computer readable medium of claim 13, wherein the selecting step is performed during an idle time period.

16. The computer readable medium of claim 13, wherein the received-data in the step of outputting includes a Unique Word field, a Radio Control Channel (RCCH) field, and a Common Control Channel (CCCH) field or a User Packet Channel (UPCH) field.
